(19) United States
(12) Patent Application Publication
(10) Pub. No.: US 2012/0287153 A1
(43) Pub. Date: Nov. 15, 2012

(54) IMAGE PROCESSING APPARATUS AND METHOD

(75) Inventors: Koji Kashima, Kanagawa (JP); Seiji Kobayashi, Tokyo (JP); Tatsumi Sakaguchi, Kanagawa (JP); Hiroshi Kajihata, Tokyo (JP)

(73) Assignee: Sony Corporation, Tokyo (JP)

(21) Appl. No.: 13/456,265

(22) Filed: Apr. 26, 2012

(30) Foreign Application Priority Data
May 13, 2011 (JP) 2011-108843

(51) Int. Cl. G09G 5/00; G06T 1/00

(52) U.S. Cl. 345/629; 345/501

(57) ABSTRACT

An image processing apparatus includes an image generation unit configured to generate an image that is obtained by photographing a subject from a different viewpoint or an image equivalent to the image obtained by photographing the subject from the different viewpoint, in conjunction with a changing amount of an attention part of the subject, as a subject image, and a display control unit configured to allow a display screen to display the subject image that is generated by the image generation unit.

### BACKGROUND

The present technology relates to image processing apparatus and method. In particular, the present technology relates to image processing apparatus and method by which a figure viewed from an arbitrary angle can be checked.

People traditionally use a mirror to check their figures. It is hard for people to check lateral and back sides of their own figures by using only one mirror, so that people use a coupled mirror obtained by combining two mirrors or a three-fold mirror. In recent years, there is a method for displaying lateral and back side figures of a person, who is photographed by a camera, simultaneously with a front side figure on a display as substitute for the method for using a coupled mirror or a three-fold mirror (for example, refer to Japanese Unexamined Patent Application Publication No. 2010-87569).

### SUMMARY

However, in the related art method disclosed in Japanese Unexamined Patent Application Publication No. 2010-87569, it is hard for a person to check his/her own figure from an angle in which a camera is not set up. Further, in the related art method disclosed in Japanese Unexamined Patent Application Publication No. 2010-87569, there is a case where a display position or a size of a person's figure on sides other than the front side are limited, so that it is difficult for a person to check a figure on sides other than the front side.

It is desirable to enable checking of one's own figure viewed from an arbitrary angle.

An image processing apparatus according to an embodiment of the present technology includes an image generation unit configured to generate an image that is obtained by photographing a subject from a different viewpoint or an image equivalent to the image obtained by photographing the subject from the different viewpoint, in conjunction with a changing amount of an attention part of the subject, as a subject image, and a display control unit configured to allow a display screen to display the subject image that is generated by the image generation unit.

The image generation unit may generate an image that is obtained by photographing the subject from a viewpoint of a reference position and a reference direction and an image equivalent to the image that is obtained by photographing the subject from the viewpoint of the reference position and the reference direction, as a reference subject image, and change at least one of the position and the direction of the viewpoint in conjunction with the changing amount when the attention part of the subject changes from an initial state in which the reference subject image is generated, so as to generate an image that is obtained by photographing the subject from the changed viewpoint or an image equivalent to the image that is obtained by photographing the subject from the changed viewpoint, as the subject image.

The image processing apparatus may further include a detection unit configured to detect a changing amount of an attention part of the subject, and the image generation unit may generate the subject image in conjunction with the changing amount that is detected by the detection unit.

The image processing apparatus may further include a plurality of photographing units that are respectively disposed on different positions and photograph the subject in separate photographing directions so as to respectively output data of photographed images, and when the position and the direction of the changed viewpoint are not accorded with a setting position and a photographing direction of any photographing unit among the plurality of photographing units, the image generation unit may composite data of photographed images outputted from photographing units that are selected from the plurality of photographing units so as to generate an image equivalent to an image obtained by photographing the subject from the changed viewpoint, as the subject image.

The changing amount of the attention part of the subject may be a rotation angle of a case where the attention part of the subject is turned and moved from the initial state.

A rotating direction may be in a horizontal direction.

The rotating direction may be in a vertical direction.

The changing amount of a case where a composite image is a still image may be a changing amount of an operation content of a gesture of the subject.

The changing amount of a case where the composite image is a moving image may be a changing amount of a position of a face of the subject or a changing amount of a direction of a line of sight of the subject.

The image generation unit may generate the subject image so that a size of the subject image and a display region of the subject image on the display screen are accorded with a size of the reference subject image and a display region of the reference subject image on the display screen.

The subject image may be an image that is obtained by photographing a past figure of the subject or an image equivalent to the image of the past figure of the subject.

The subject image may be an image that is obtained by photographing another subject that is different from the subject or an image equivalent to the image that is obtained by photographing the other subject.

The display control unit may allow to superimpose two or more images among an image obtained by photographing a past figure of the subject or an image equivalent to the image obtained by photographing the past figure of the subject, an image obtained by photographing a current figure of the subject or an image equivalent to the image obtained by photographing the current figure of the subject, and an image obtained by photographing a future figure of the subject or an image equivalent to the image obtained by photographing the future figure of the subject, as the subject image so as to display the superimposed image.

The display control unit may allow to display two or more images side by side among the image obtained by photographing the past figure of the subject or the image equivalent to the image obtained by photographing the past figure of the subject, the image obtained by photographing the current figure of the subject or the image equivalent to the image obtained by photographing the current figure of the subject, and the image obtained by photographing the future figure of the subject or the image equivalent to the image obtained by photographing the future figure of the subject, as the subject image.

The display control unit may allow to display the image obtained by photographing the past figure of the subject or the image equivalent to the image obtained by photographing the past figure of the subject, the image obtained by photographing the current figure of the subject or the image equivalent to the image obtained by photographing the current figure of the subject, and the image obtained by photographing the future figure of the subject or the image equivalent to the image obtained by photographing the future figure of the subject, in a manner to make the respective images have different transmittance.

An image processing method according to another embodiment of the present technology corresponds to the image processing apparatus of the above-described embodiment of the present technology.

An image processing apparatus and method according to another embodiment of the present technology generates an image that is obtained by photographing a subject from a different viewpoint or an image equivalent to the image obtained by photographing the subject from the different viewpoint, in conjunction with a changing amount of an attention part of the subject, as a subject image, and allows a display screen to display the subject image that is generated.

As described above, according to the embodiments of the present technology, own figure viewed from an arbitrary angle can be checked.

### BRIEF DESCRIPTION OF THE DRAWINGS

FIG. 1 illustrates an outline of an embodiment of the present technology;

FIG. 2 illustrates a relationship between a changing amount of a face of a user and a predetermined viewpoint;

FIG. 3 schematically illustrates a method for generating data of a user image;

FIG. 4 schematically illustrates the method for generating data of the user image;

FIG. 5 illustrates an external configuration example of a display type mirror apparatus;

FIG. 6 is a block diagram illustrating a functional configuration example of a main control device;

FIG. 7 is a flowchart illustrating an example of display processing;

FIG. 8 illustrates a method for switching over a display content of the user image;

FIG. 9 illustrates another external configuration example of a display type mirror apparatus;

FIG. 10 illustrates a display example in a superimposition display mode;

FIG. 11 illustrates a display example in a parallel display mode; and

FIG. 12 is a block diagram illustrating a configuration example of hardware of an image processing apparatus according to the embodiment of the present technology.

### DETAILED DESCRIPTION OF EMBODIMENTS

### [Outline of Embodiment of Present Technology]

An outline of an embodiment of the present technology is first described to make understanding of the present technology easy.

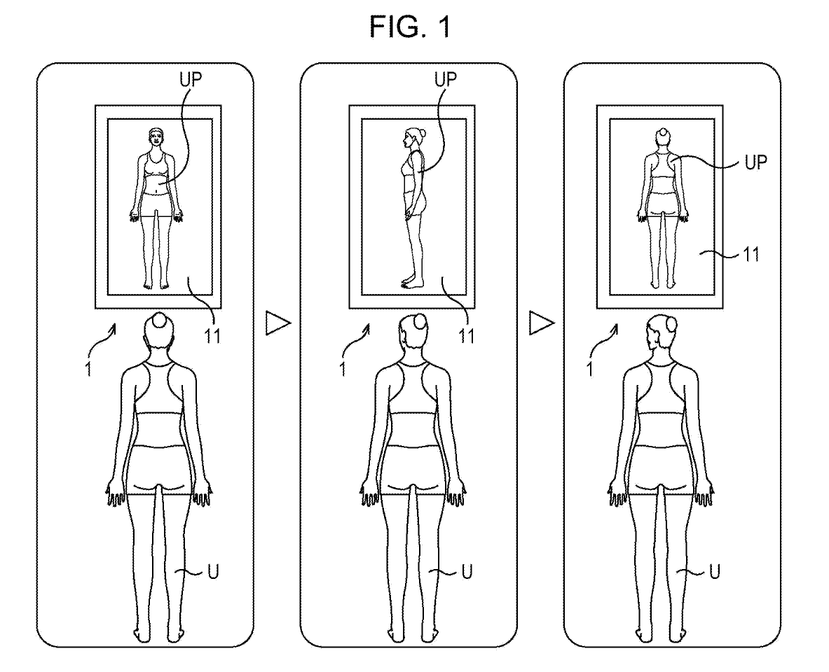

FIG. 1 illustrates an outline of the embodiment of the present technology.

A display type mirror apparatus 1 according to the embodiment of the present technology includes a display 11 and a camera (not depicted in FIG. 1) for photographing a front image of a user U who is a person being on a position opposed to the display 11.

Here, the front image of the user U includes not only a photographed image which is photographed by a single camera but also a composite image obtained by processing a plurality of photographed images which are respectively photographed by a plurality of cameras. In other words, the camera for photographing the front image of the user U includes not only a single camera which photographs the user U from the front but also a plurality of cameras which photograph the user U from various directions. Therefore, not only a photographed image which is photographed by a single camera and directly used as a front image but also a composite image which is obtained by processing a plurality of photographed images photographed by a plurality of cameras and used as a front image are referred to a front image which is photographed by a camera.

When the user U stands on a position opposed to the display 11, as an image of an initial state, the display 11 displays a front image which is photographed by a camera, that is, an image equivalent to a mirror image which is obtained when the display 11 is assumed as a mirror, as a user image UP, as depicted in a left diagram of FIG. 1. Here, the system of the display 11 is not especially limited, but may be a system displaying a common two-dimensional image or a system enabling three-dimensional viewing.

When the user U moves her/his face, a figure of the user image UP displayed on the display 11 changes. Specifically, a user image UP which is obtained when the user U is photographed from a predetermined viewpoint is displayed on the display 11. In a case of the initial state, for example, a direction toward the front (that is, a display surface) from the back of the display 11 is set to be a direction of a predetermined viewpoint. As a result, the front image of the user U is displayed on the display 11 as the user image UP.

A position and a direction of a predetermined viewpoint from which the user U is photographed change in conjunction with a moving direction and a moving amount of a face of the user U (hereinafter, referred to collectively as a changing amount by combining the moving direction and the moving amount). That is, when the user U moves her/his face after the user U stands opposed to the display 11, the position and the direction of the predetermined viewpoint also change in conjunction with the changing amount. Then, an image obtained when the user U is photographed from the predetermined viewpoint obtained after the position and the direction change is displayed on the display 11 as the user image UP.

For example, in a case where the position and the direction of the predetermined viewpoint change until a lateral side of the user U is photographed, a lateral image of the user U is displayed on the display 11 as the user image UP, as depicted in a central diagram of FIG. 1.

When the face of the user U further moves and the changing amount of the face is further increased, the position and the direction of the predetermined viewpoint further change in conjunction with the changing amount. For example, in a case where the position and the direction of the predetermined viewpoint change until a rear side of the user U is photographed, a rear image of the user U is displayed on the display 11 as the user image UP, as depicted in a right diagram of FIG. 1.

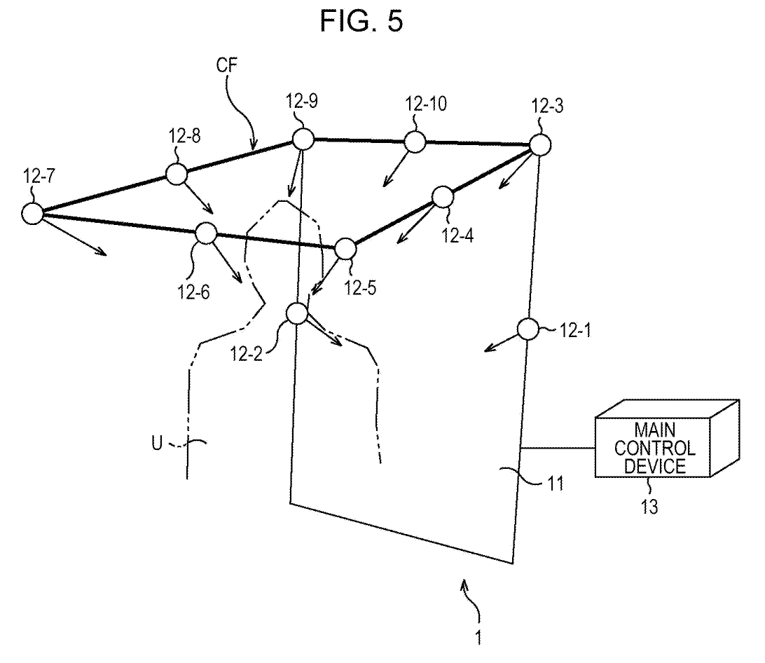

Here, though they are not depicted in FIG. 1, a plurality of cameras for photographing the user U, other than the above-described camera for photographing a front image of the user U, are disposed on various positions in the display type mirror apparatus 1 (refer to FIG. 5 described later). Accordingly, in a case where a setting position and a photographing direction (that is, an optical axis direction of a lens) of one camera among these plurality of cameras are accorded with a position and a direction of a predetermined viewpoint, a photographed image obtained when the one camera actually photographs the user U is displayed on the display 11 as the user image UP.

However, there is a limit in a setting number of the plurality of cameras, so that it is rare that the position and the direction of the predetermined viewpoint which freely changes are accorded with the setting position and the photographing direction of the camera. Therefore, when the position and the direction of the predetermined viewpoint are not accorded with a setting position and a photographing direction of any cameras, the display type mirror apparatus 1 selects a plurality of cameras which are disposed on positions close to the predetermined viewpoint. Then, the display type mirror apparatus 1 composites data of a plurality of photographed images which are obtained by actually photographing the user U by a plurality of selected cameras, so as to generate data of a composite image which is equivalent to an image obtained by virtually photographing the user U from the predetermined viewpoint. Then, the display type mirror apparatus 1 displays the composite image on the display 11 as the user image UP.

Thus, when the face of the user U moves, the display type mirror apparatus 1 updates the position and the direction of the predetermined viewpoint in conjunction with the changing amount of the face and displays an image obtained when the user U is photographed from a position and a direction of an updated predetermined viewpoint, on the display 11. Accordingly, the user U can check her/his own figure which is as if her/his own figure was viewed from a predetermined viewpoint on arbitrary position and direction, only by performing a simple and intuitive operation such as standing in front of the display 11 of the display type mirror apparatus 1 and then moving her/his face to a predetermined direction by a predetermined amount while keeping directing the line of sight to the display 11.

The display type mirror apparatus 1 according to the embodiment of the present technology is described below.

[Relationship between Changing Amount of Face and Photographing Angle of Predetermined Camera]

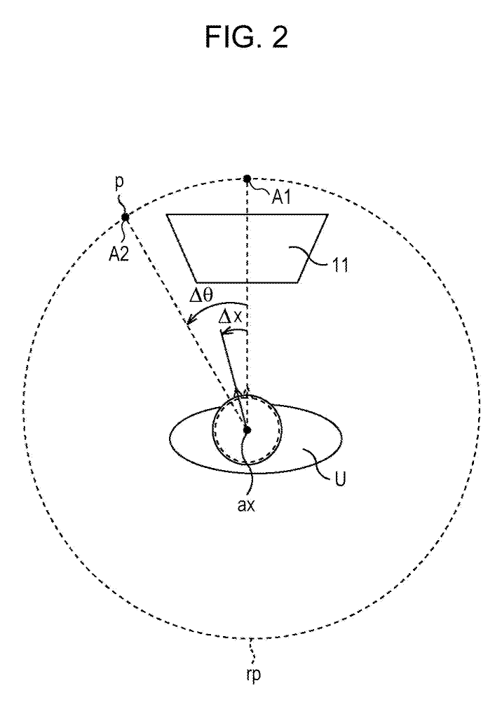

FIG. 2 illustrates a relationship between a changing amount of the face of the user U and a predetermined viewpoint.

Here, a direction passing through a center (a part of a nose in FIG. 2) from the back of the head of the user U to the face is referred to below as a user viewing direction. Further, a state in which the user U stands on a position opposed to the display surface of the display 11 and a normal direction of the display 11 and the user viewing direction are approximately accorded with each other is set as an initial state. That is, in a case of the initial state, a front image of the user U is displayed on the display 11 as the user image UP as depicted in the above-described left drawing of FIG. 1.

It is assumed that the user U turns her/his face in a counterclockwise rotation, for example, in a horizontal direction (that is, a direction parallel to a face of FIG. 2) about an axis ax which passes through a center of the head in a vertical direction. In this case, a moving amount Δx of the face of the user U can be expressed by an angle between the user viewing direction in the initial state (that is, a direction approximately accorded with the normal direction of the display 11) and the user viewing direction after moving the face, as depicted in FIG. 2. Further, a viewpoint P which changes in conjunction with the moving amount Δx is predetermined, and the changing amount Δθ is expressed as the following formula (1), for example.

Δθ=a×Δx+b (1)

In the formula (1), coefficients a and b are parameters for adjustment, and a designer, a manufacturer, or the user U of the display type mirror apparatus 1 can arbitrarily change and set the coefficients a and b.

That is, the viewpoint P corresponds to a position on which a camera for photographing an image of the user U which is displayed on the display 11 is virtually disposed and the viewpoint P moves along a predetermined circumference rp centered at the axis ax of the center of the head of the user U. In particular, when it is assumed that a position A1 of the viewpoint P on the circumference rp in the initial state is set to be an initial position, the viewpoint P moves from the initial position A1 to a position A2 on the circumference rp which corresponds to rotation of the changing amount Δθ, in conjunction with the move of the face of the user U by the moving amount Δx. In this case, the viewpoint P directs the user U along a line connecting the viewpoint P with the axis ax of the center of the head of the user U. Accordingly, an image obtained when the user U is photographed in a manner that the viewpoint P existing on the position A2 on the circumference rp is oriented in the direction to the axis ax of the center of the head of the user U is displayed on the display 11 as the user image UP.

Here, as described above, it is rare that the position A2 and the direction of the viewpoint P which is specified by the changing amount Δθ are accorded with the setting position and the photographing direction of a camera which is actually disposed in the display type mirror apparatus 1. Accordingly, the display type mirror apparatus 1 commonly selects a plurality of cameras which are disposed on positions close to the viewpoint P and composites data of a plurality of photographed images which are obtained by actually photographing the user U by the plurality of selected cameras, so as to generate data of the user image UP from the viewpoint P.

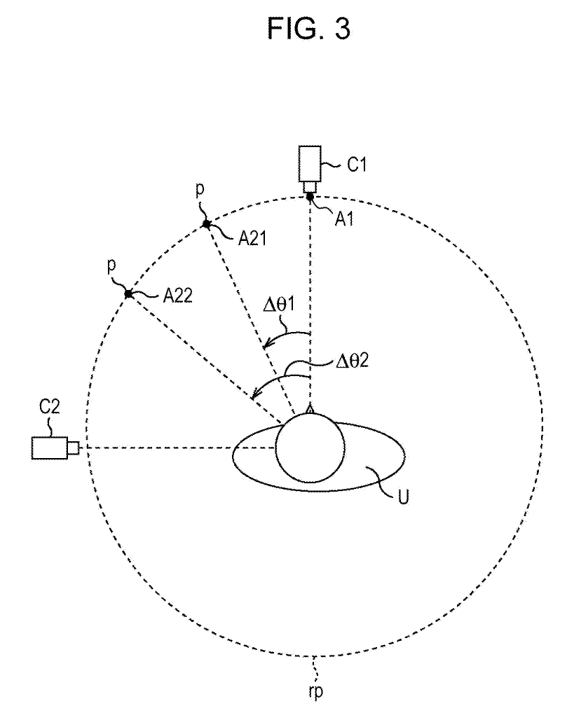

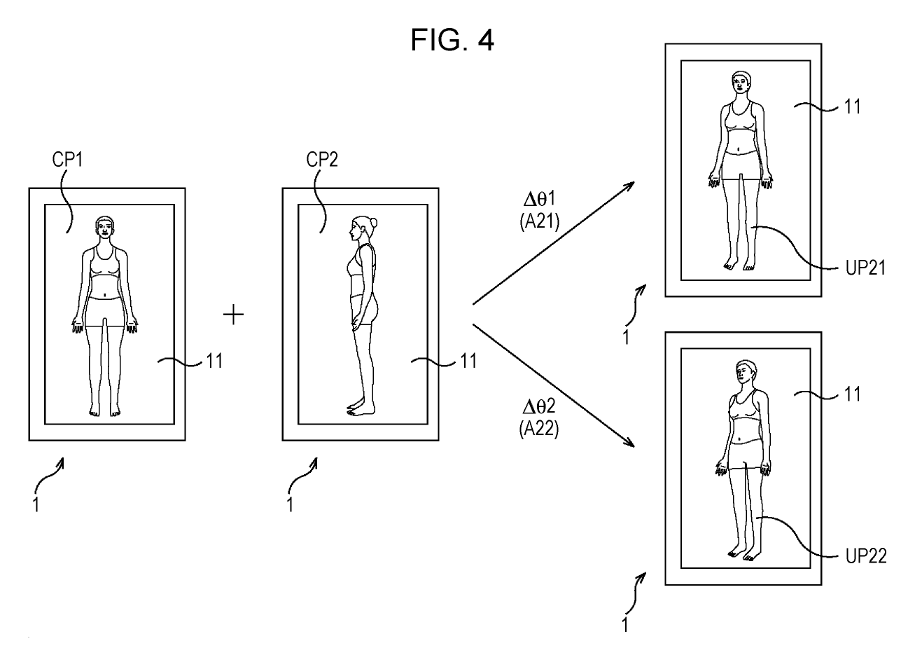

Hereinafter, a method for generating data of the user image UP in a case where the position A2 and the direction of the viewpoint P which are specified by the changing amount Δθ are not accorded with a setting position and a photographing direction of any camera of the display type mirror apparatus 1 is described with reference to FIGS. 3 and 4.

### [Prerequisite of Method for Generating Data of User Image UP]

FIG. 3 schematically illustrates the method for generating data of the user image UP and shows prerequisites of the description.

In an example of FIG. 3, a camera C1 is disposed on a position on which the camera C1 can photograph the front side of the user U, that is, on a position corresponding to the initial position A1 on the circumference rp. Further, a camera C2 is disposed on a position on which the camera C2 can photograph a left lateral side of the user U, that is, on a position which is moved from the initial position A1 in a left direction along the circumference rp by 90 degrees.

Here, as an example of a case where the viewpoint P moves to a position other than setting positions of the camera C1 and the camera C2, a case where the viewpoint P moves to a first position A21 on the circumference rp corresponding to the changing amount Δθ1 and a case where the viewpoint P moves to a second position A22 on the circumference rp corresponding to the changing amount Δθ2 are respectively assumed, as shown in FIG. 3.

### [Specific Example of Method for Generating Data of User Image UP]

FIG. 4 schematically illustrates the method for generating data of the user image UP and shows a specific example of data of the user image UP generated based on the prerequisites of FIG. 3.

In FIG. 4, a photographed image CP1 is an image obtained by actually photographing the user U by the camera C1 and a photographed image CP2 is an image obtained by actually photographing the user U by the camera C2.

In a case where the viewpoint P moves by the changing amount Δθ1 to be on a position A21 on the circumference rp, the display type mirror apparatus 1 composites data of the photographed image CP1 of the camera C1 and data of the photographed image CP2 of the camera C2 so as to generate data of a composite image equivalent to an image which is obtained by virtually photographing the user U from the viewpoint P, as data of the user image UP21, as depicted in an upper right diagram of FIG. 4.

On the other hand, in a case where the viewpoint P moves by the changing amount Δθ2 to be on a position A22 on the circumference rp, the display type mirror apparatus 1 composites the data of the photographed image CP1 of the camera C1 and the data of the photographed image CP2 of the camera C2. Accordingly, data of a composite image equivalent to an image which is obtained by virtually photographing the user U from the viewpoint P is generated, as data of the user image UP22, as depicted in a lower right diagram of FIG. 4. In a case where the user U turns her/his face in an inverse direction, that is, a clockwise rotation in the horizontal direction, data of a composite image equivalent to an image obtained by virtually photographing the user U from the viewpoint P on a right direction is generated as data of the user image UP. That is, the display type mirror apparatus 1 generates data of the user image UP by using a photographed image of a predetermined camera which is disposed in a right direction of the user U.

Thus, even in a case where the position and the direction of the viewpoint P are not accorded with a setting position and a photographing direction of any camera, data of a composite image which is generated from data of photographed images obtained by a plurality of cameras can be employed as data of the user image UP. Accordingly, setting number of cameras in the display type mirror apparatus 1 can be reduced, and therefore, the manufacturing cost of the display type mirror apparatus 1 can be reduced.

Further, the user image UP displayed on the display 11 smoothly changes in response to the move of the face of the user U, so that the user U can check the change of own figure without feeling of strangeness.

Here, the user image UP displayed on the display 11 may be either a still image or a moving image. Further, the user U can arbitrarily set a frame rate of the user image UP displayed on the display 11. Further, an upper limit may be set in the changing amount Δθ of the viewpoint P which changes in conjunction with the moving amount Δx by setting a predetermined threshold value on the moving amount Δx of the face of the user U. In this case, it may be set that when the moving amount Δx of the face of the user U becomes larger than the predetermined threshold value, a display content of the user image UP generated based on the viewpoint P which changes in conjunction with the moving amount Δx is prevented from further changing.

The display type mirror apparatus 1 may stop a display content of the user image UP which changes in conjunction with the moving amount Δx of the face of the user U, in accordance with a predetermined operation by the user U. Accordingly, after stopping the display content of the user image UP, the user U can check her/his own figure which is as if the user U looks at herself/himself from a predetermined viewpoint of arbitrary position and direction in an arbitrary posture, for example, a posture that the user U turns her/his face toward the facade of the display 11.

Further, in a case where the display type mirror apparatus 1 generates the user image UP from data of photographed images obtained by a plurality of cameras, the display type mirror apparatus 1 may use a shape of a human body as a constraint condition.

An external appearance of the display type mirror apparatus 1 is now described.

### [External Configuration Example of Display Type Mirror Apparatus 1]

FIG. 5 illustrates an external configuration example of the display type mirror apparatus 1.

As depicted in FIG. 5, the display type mirror apparatus 1 includes cameras 12-1 to 12-10 (arbitrarily including the cameras C1 and C2 of FIG. 3) and a main control device 13 in addition to the display 11 described above. The cameras 12-1 and 12-2 are disposed on the lateral sides of the display 11 and the cameras 12-3 to 12-10 are disposed in a manner to be held by a camera holding frame CF in an approximately same interval. When it is not necessary to individually distinguish the cameras 12-1 to 12-10, these cameras are collectively referred to as the cameras 12.

The camera holding frame CF is disposed on a position on which the camera holding frame CF does not disturb movements of the user U, for example, disposed above a standing position of the user U (a position higher than the height of the user U) in the example of FIG. 5. In this case, photographing directions of the cameras 12-3 to 12-10 disposed on the camera holding frame CF are in the obliquely-downward direction as expressed by arrows in the drawing. As a result, photographed images obtained by photographing the user U by the cameras 12-3 to 12-10 show the user U who is looked down from above. On the other hand, in terms of the cameras 12-1 and 12-2 which are disposed on the lateral sides of the display 11 at the level of approximately half of the height of the user U, the photographing direction is in the horizontal direction, but the setting positions are lower than the face of the user U. As a result, photographed images obtained by photographing the user U by the cameras 12-1 and 12-2 mainly show a body which is below the face of the user U. Accordingly, the display type mirror apparatus 1 arbitrarily composites data of photographed images outputted from the cameras 12-1 and 12-2 with data of photographed images outputted from some of the cameras 12-3 to 12-10 which are disposed on the camera holding frame CF, being able to generate data of an image, in which the whole figure of the user U is viewed from the horizontal direction, as data of the user image UP. Therefore, the cameras 12 may be disposed close to a floor, on which the user U stands, in a manner to surround the user U and composite data of photographed images outputted from the cameras 12 disposed on the upper side and the lower side.

Here, the shape of the camera holding frame CF is a square shape in the example of FIG. 5. However, the shape is not limited to the example of FIG. 5, but the shape may be other shape such as a rectangular shape and a circular shape. Further, the setting positions of the cameras 12 are not limited to the example of FIG. 5, but the cameras 12 may be set in a movable manner, for example. Furthermore, the setting number of the cameras 12 is not limited to the example of FIG. 5. Furthermore, the cameras 12 may be commonly-used single-lens cameras or stereo cameras.

Respective communication systems of the display 11, the cameras 12, and the main control device 13 are not especially limited but may be a wired system or a wireless system. Further, in the example of FIG. 5, the display 11 and the main control device 13 are configured in a physically separated manner. However, the configurations of the display 11 and the main control device 13 are not especially limited to the example of FIG. 5, but the display 11 and the main control device 13 may be configured in an integrated manner.

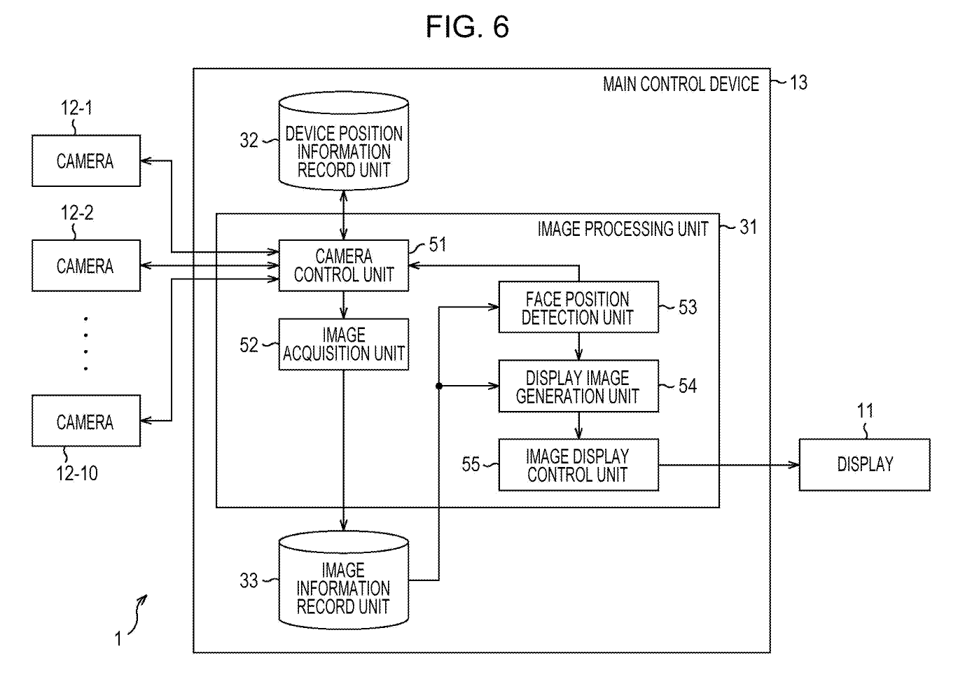

Among functions of the main control device 13 of the display type mirror apparatus 1 depicted in FIG. 5, a functional configuration example for realizing various functions to display the user image UP on the display 11 is now described with reference to FIG. 6.

### [Functional Configuration Example of Main Control Device 13 of Display Type Mirror Apparatus 1]

FIG. 6 is a block diagram illustrating a functional configuration example of the main control device 13 of the display type mirror apparatus 1.

The main control device 13 of the display type mirror apparatus 1 of FIG. 6 includes an image processing unit 31, a device position information record unit 32, and an image information record unit 33. The image processing unit 31 is composed of a camera control unit 51, an image acquisition unit 52, a face position detection unit 53, a display image generation unit 54, and an image display control unit 55.

The camera control unit 51 controls so that at least one camera among the cameras 12-1 to 12-10 photographs the user U.

When respective data of photographed images are outputted from one or more cameras among the cameras 12-1 to 12-10, the image acquisition unit 52 acquires the respective data of the photographed images, so as to store the respective data in the image information record unit 33, in accordance with the control of the camera control unit 51.

The device position information record unit 32 preliminarily records information, which represents a positional relationship relative to the display 11 (referred to below as device position information), of each of the cameras 12-1 to 12-10. When the image acquisition unit 52 acquires data of a photographed image of a camera 12-K (K is an arbitrary integer among 1 to 10), the image acquisition unit 52 reads device position information of the camera 12-K from the device position information record unit 32 so as to allow the image information record unit 33 to record the device position information with data of the photographed image of the camera 12-K.

The face position detection unit 53 reads out data of a photographed image from the image information record unit 33 so as to detect a position of the face of the user U from the photographed image. The detection result of the face position detection unit 53 is supplied to the display image generation unit 54. Here, the detection result of the face position detection unit 53 is also supplied to the camera control unit 51 as necessary. In this case, the camera control unit 51 can narrow down cameras to be operated among the cameras 12-1 to 12-10, that is, cameras which are allowed to output data of photographed images which are acquired by the image acquisition unit 52, based on the detection result.

The display image generation unit 54 calculates a moving amount Δx of the face of the user U from each position of the face of the user U which is detected from each of data of a plurality of photographed images which are photographed in a temporally-separate manner. Then, the display image generation unit 54 assigns the moving amount Δx to the formula (1) so as to calculate the changing amount Δθ of the viewpoint P. Further, the display image generation unit 54 reads out data of a photographed image from the image information record unit 33 so as to generate data of an image equivalent to an image obtained by photographing the user U from the viewpoint P which is moved by the changing amount Δθ, as data of the user image UP.

The image display control unit 55 allows the display 11 to display the user image UP corresponding to the data generated by the display image generation unit 54.

Here, device position information may be regularly acquired with the data of the photographed image of the camera 12-K by the image acquisition unit 52 without being preliminarily recorded in the device position information record unit 32.

An example of displaying the user image UP (referred to below as display processing) by the display type mirror apparatus 1 having such configuration is described.

### [Display Processing]

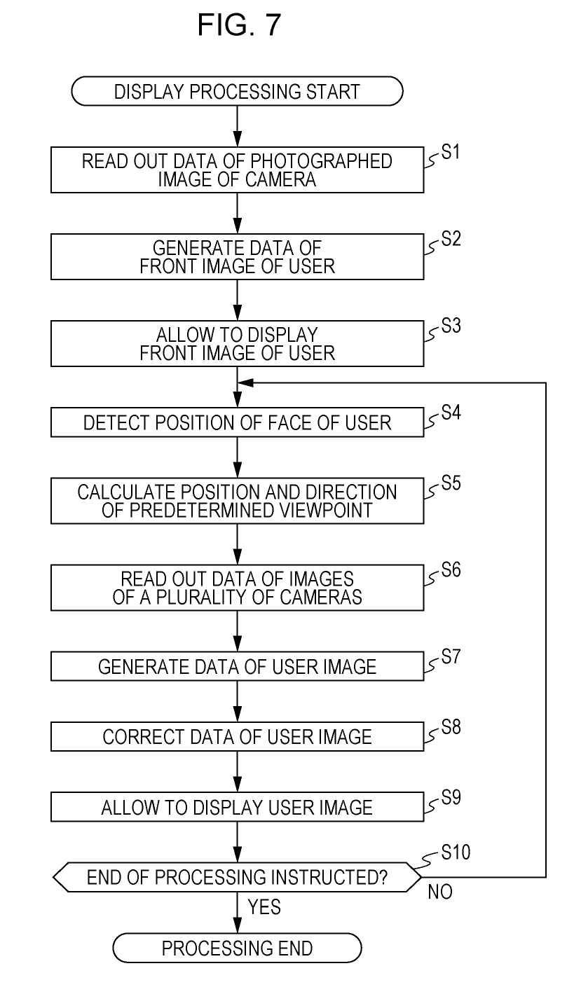

FIG. 7 is a flowchart illustrating an example of the display processing.

When the user U stands on a position opposed to the display 11, the display type mirror apparatus 1 starts the processing.

In step S1, the display image generation unit 54 reads out data of a photographed image of the cameras 12. That is, the display image generation unit 54 reads out data, which is necessary for generating data of a front image of the user U, of photographed images obtained by photographing by the cameras 12, from the image information record unit 33, in accordance with the control of the camera control unit 51. In this case, data of photographed images obtained by photographing by the cameras 12-1, 12-2, and 12-10, for example, are read out.

In step S2, the display image generation unit 54 generates data of a front image of the user U from respective image data read out in step S1.

In step S3, the image display control unit 55 allows the display 11 to display the front image of the user U. That is, the image display control unit 55 allows the display 11 to display the front image of the user U corresponding to the data generated by the display image generation unit 54 in step S2, as the user image UP.

In step S4, the face position detection unit 53 reads out the data of the photographed images from the image information record unit 33 so as to detect a position of the face of the user U from the data of the photographed images.

In step S5, the display image generation unit 54 calculates a position and a direction of the viewpoint P after the movement (including no movement) from the previous time. That is, the display image generation unit 54 calculates the moving amount Δx of the face of the user U from the position of the face of the user U detected by the face position detection unit 53. Then, the display image generation unit 54 carries out an operation by assigning the moving amount Δx into the formula (1) to calculate a changing amount Δθ of the viewpoint P, thus specifying the position and the direction of the viewpoint P.

In step S6, the display image generation unit 54 reads out data of the photographed image outputted from one or more cameras 12 which is on the position of the viewpoint P or are close to the position of the viewpoint P from the image information record unit 33.

In step S7, the display image generation unit 54 generates data of the user image UP based on data of one or more photographed image(s) read out in step S6. That is, the display image generation unit 54 generates data of an image equivalent to an image obtained by photographing the user U from the viewpoint P which is moved by the changing amount Δθ which is calculated in step S5, as data of the user image UP.

In step S8, the display image generation unit 54 corrects the data of the user image UP. That is, the display image generation unit 54 corrects the data of the user image UP so that a size of the whole body of the user U expressed by data of the user image UP generated in step S7 (that is, occupancy of a region of the whole body of the user U in a display screen of the display 11) corresponds to the data of the front image generated in step S2 (that is, displayed heights are accorded with each other). Further, the display image generation unit 54 allows a display region, on the display 11, of the user image UP expressed by the data of the user image UP generated in step S7 to correspond to the data of the front image of the user U generated in step S2. This correction is performed so as not to provide a feeling of strangeness to the user U.

In step S9, the image display control unit 55 allows the display 11 to display the user image UP which is corrected. At this time, the user U can check the user image UP by directing only the line of sight to the display 11 while moving the position of the face.

In step S10, the image processing unit 31 determines whether an end of the processing is instructed. Here, the instruction of the end of the processing is not especially limited. For example, detection of the camera 12 that the user U no more exists in front of the display 11 may be used as an instruction of the end of the processing. Further, for example, user U's expressing operation for instructing the end of the processing may be the instruction of the end of the processing.

When the end of the processing is not instructed, it is determined to be NO in step S10. Then, the processing is returned to step S4 and the processing of step S4 and the following processing are repeated. That is, loop processing from step S4 to step S10 is repeated until the end of the processing is instructed.

After that, when the end of the processing is instructed, it is determined to be YES in step S10 and the display processing is ended.

Here, the user U can arbitrarily set the size of the user image UP which is displayed on the display 11, in steps S3 and S9. For example, the user U can allow the display 11 to display the user image UP of a slenderer or taller figure than the actual own figure. Further, a display region of the user image UP which is displayed on the display 11 in steps S3 and S9 may regularly be a center or an arbitrary region in the display region of the display 11. For example, when the display type mirror apparatus 1 recognizes that the user U stands and gets still on a position opposed to the display 11 for equal to or more than predetermined time (for example, several seconds), the display type mirror apparatus 1 may display the user image UP in the display region of the display 11, that frontally faces the position.

In the above-described example, a display content (that is, a posture of the user U) of the user image UP which is displayed on the display 11 is switched over as the position and the direction of the viewpoint P change in conjunction with the moving amount Δx of the face of the user U. However, switching of the display content of the user image UP may be performed by changing the position and the direction of the viewpoint P in conjunction with change of other object.

### [Method for Switching Over Display Content of User Image UP]

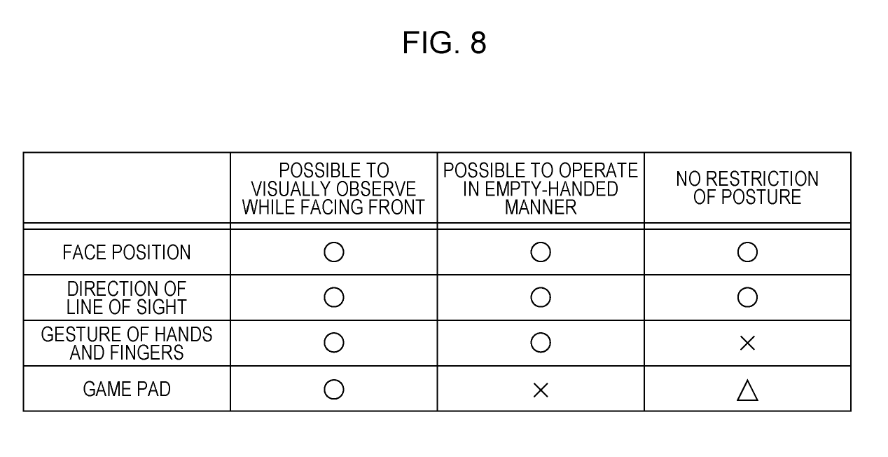

FIG. 8 illustrates a method for switching over a display content of the user image UP.

As the method for switching over a display content of the user image UP, several methods are applicable depending on a type of an operation of the user U. In the example of FIG. 8, there are methods for changing a position and a direction of the viewpoint P in conjunction with a moving operation of a position of the face of the user U, in conjunction with a moving operation of a direction of the line of sight of the user U, in conjunction with a gesture operation of hands and fingers, and in conjunction with an operation with a game pad which is separately provided.

These methods are individually described below while being compared on points of three features which are “possible to visually observe while facing the front”, “possible to operate in an empty-handed manner”, and “no restriction of a posture”. Here, “possible to visually observe while facing the front” represents a state that the user U can visually observe the user image UP, which is displayed, while facing the front with respect to the display 11, and operations employed in respective methods can be performed. “Possible to operate in an empty-handed manner” represents that operations employed in the respective methods can be performed in a state that the user U is empty-handed. “No restriction of a posture” represents that operations employed in the respective methods can be performed in a state that a posture of the user U is not restricted.

The method for switching over a display content of the user image UP in conjunction with a moving operation of the position of the face is such a method that when the user U performs an operation to move the position of her/his face, the position and the direction of the viewpoint P change in conjunction with the moving amount Δx of the position of the face and thereby a display content of the user image UP displayed on the display 11 is switched over. As illustrated in FIG. 8 such that circles are depicted for respective items, in use of this method, the user U can operate the moving operation of her/his face in a manner that the user U can visually observe the user image UP displayed on the display 11 while facing the front in an empty-handed fashion and the posture of the user U is not restricted.

The method for switching over a display content of the user image UP in conjunction with the moving operation of a direction of the line of sight is such a method that when the user U performs an operation to move the direction of the line of sight, the position and the direction of the viewpoint P change in conjunction with the moving amount Δx of the line of sight and thereby a display content of the user image UP displayed on the display 11 is switched over. As illustrated in FIG. 8 such that circles are depicted for respective items, in use of this method, the user U can operate the moving operation of the direction of the line of sight in a manner that the user U can visually observe the user image UP displayed on the display 11 while facing the front in an empty-handed fashion and the posture of the user U is not restricted. As described above, the user U can stop the display content of the user image UP by performing a predetermined operation. As the predetermined operation, user U's operation of blinking for equal to or more than predetermined time can be employed, for example. Accordingly, after the user U stops the display content of the user image UP by the operation of blinking for equal to or more than the predetermined time and the like, the user U can check a figure which is as if the user U herself/himself is viewed from a predetermined viewpoint of arbitrary position and direction, while directing the line of sight to the facade of the display 11.

The method for switching over a display content of the user image UP in conjunction with a gesture operation of hands and fingers is such a method that when the user U performs a predetermined gesture operation of hands and fingers, the position and the direction of the viewpoint P change in conjunction with change of the operation content and thereby the display content of the user image UP displayed on the display 11 is switched. As illustrated in FIG. 8 such that circles and a cross mark are depicted for respective items, in use of this method, the user U can operates the gesture operation of hands and fingers in a manner that the user U can visually observe the user image UP displayed on the display 11 while facing the front in an empty-handed fashion. However, the user U performs the gesture operation of hands and fingers in a state that a posture is restricted.

The method for switching over a display content of the user image UP in conjunction with an operation with a game pad is such a method that when the user U performs an operation with respect to a game pad, the position and the direction of the viewpoint P change in conjunction with the change of the operation content and thereby the display content of the user image UP displayed on the display 11 is switched. As illustrated in FIG. 8 such that circles, a cross mark, and a triangular mark are depicted for respective items, in use of this method, the user U can performs the operation with respect to a game pad in a manner that the user U can visually observe the user image UP displayed on the display 11 while facing the front. However, the user U may not perform the operation with respect to the game pad in an empty-handed fashion. Further, the user U has a little difficulty performing the operation with respect to the game pad without any restriction of the posture of the user U.

Thus, as the operation of the user U for switching over a display content of the user image UP, it is favorable to employ an operation meeting all of the points of the three features which are “possible to visually observe while facing the front”, “possible to operate in an empty-handed fashion”, and “no restriction of a posture”, that is, the above-described moving operation of the position of the face and the above-described moving operation of the direction of the line of sight. If some points of the three features can be sacrificed, various types of operations such as the gesture operation of hands and fingers and the operation with the game pad may be employed as the operation of the user U for switching over a display content of the user image UP.

In a case where the user image UP displayed on the display 11 is a still image, it is favorable that the gesture operation of hands and fingers is employed as the method for switching over a display content of the user image UP. On the other hand, in a case where the user image UP displayed on the display 11 is a moving image, it is favorable that the moving operation of the face of the user U and the moving operation of the direction of the line of sight are employed as the method for switching over a display content of the user image UP.

In any case, a simple and intuitive operation which does not impose a load on a user may be employed as the operation of the user U for switching over a display content of the user image UP. Here, it should be noted that the operation of the user U for switching over a display content of the user image UP is not limited to the above-described examples.

### [Another External Configuration Example of Display Type Mirror Apparatus 1]

In the above-described example, in the display type mirror apparatus 1, a plurality of cameras 12 are disposed on the camera holding frame CF. However, the external configuration of the display type mirror apparatus 1 is not limited to this.

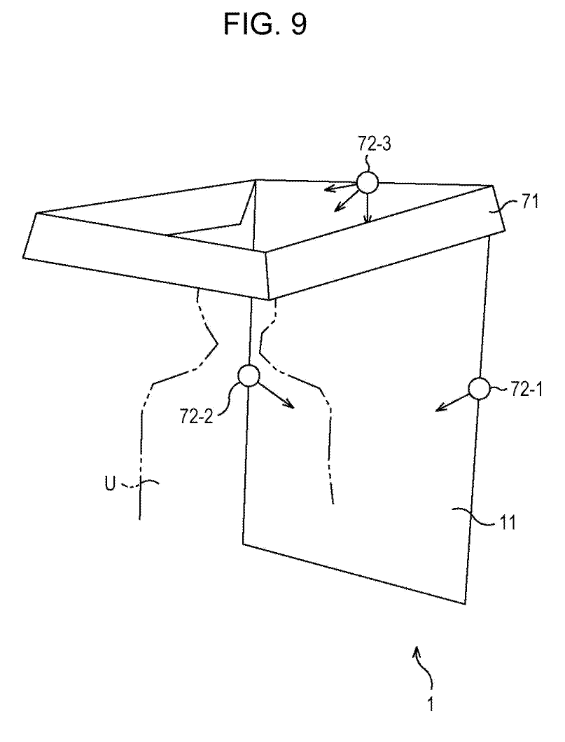

FIG. 9 illustrates another external configuration example of the display type mirror apparatus 1.

As depicted in FIG. 9, the display type mirror apparatus 1 includes the display 11, a circumference mirror 71, and cameras 72-1 to 72-3. The cameras 72-1 and 72-2 are disposed on lateral sides of the display 11 and the camera 72-3 is disposed on an upper side of the display 11. The circumference mirror 71 is disposed on a position on which the circumference mirror 71 does not interrupt movement of the user U, for example, disposed above the standing position of the user U in the example of FIG. 9. When it is not necessary to individually distinguish the cameras 72-1 to 72-3, these cameras are collectively referred to as the cameras 72.

The camera 72-3 photographs the user U reflected on the circumference mirror 71. That is, the camera 72-3 arbitrarily moves a photographing direction to take luminous flux reflected by the circumference mirror 71 in, being able to output data of photographed images equivalent to images obtained by photographing the user U from a plurality of directions. That is, the camera 72-3 independently exerts the function same as that of the plurality of cameras 12-3 to 12-10 which are disposed on the camera holding frame CF of FIG. 5. Further, by precisely controlling the movement of the photographing direction of the camera 72-3, data of one photographed image can be directly employed as data of the user image UP obtained by photographing the user U from an arbitrary direction, without compositing data of a plurality of photographed images.

Here, the circumference mirror 71 has a square shape in the example of FIG. 9, but the shape of the circumference mirror 71 is not limited to the example of FIG. 9. The circumference mirror 71 may have other shape such as a circular shape or a domed shape. Further, the setting positions of the cameras 72 are not limited to the example of FIG. 9, but the cameras 72 may be movable, for example. Furthermore, the setting number of the cameras 72 is not limited to the example of FIG. 9.

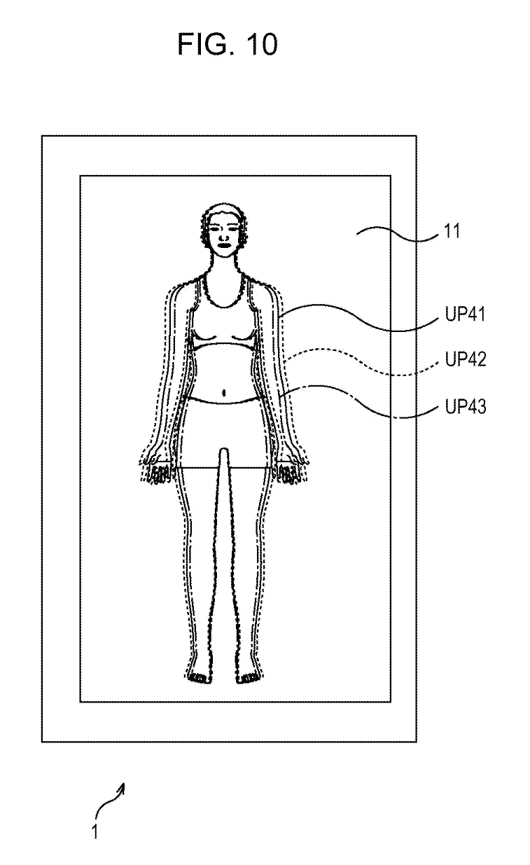

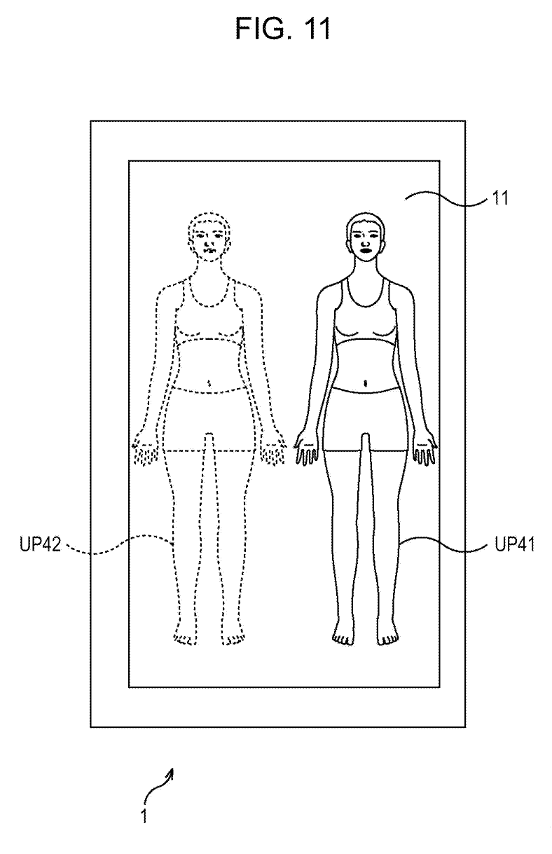

In the above-described example, a current figure of the user U is displayed on the display 11 as the user image UP. However, the user image UP may be a past or future figure of the user U or a figure of other person who is not the user U. In this case, the user U can allow the display type mirror apparatus 1 to superimpose a user image UP of a past or future figure of the user U or a user image UP of a figure of other person on the user image UP of a current figure of the user U to display the superimposed image or to display the user image UP of a past or future figure of the user U or the user image UP of a figure of other person and the user image UP of a current figure of the user U side by side. Hereinafter, the former displaying method of the user image UP is referred to as a superimposition display mode, and the latter displaying method of the user image UP is referred to as a parallel display mode. A display example of the user image UP is described with reference to FIGS. 10 and 11.

### [Display Example in Superimposition Display Mode]

FIG. 10 illustrates a display example in the superimposition display mode.

A user image UP41 which is displayed on the display 11 and depicted by a solid line, a user image UP42 which is displayed on the display 11 and depicted by a dotted line, and a user image UP43 which is displayed on the display 11 and depicted by a dashed-dotted line respectively represent a current figure, a past figure, and a future figure of the user U. As depicted in FIG. 10, in the superimposition display mode, the user image UP42 and the user image UP43 are superimposed with reference to the display region of the user image UP41 so as to be displayed on a display region of the user image UP41 in a manner that centers of bodies are accorded with each other.

The user image UP42 which shows a past figure of the user U is generated by the display image generation unit 54 by using data of a past photographed image of the user U recorded in the image information record unit 33. The user image UP43 which shows a future figure of the user U is generated by the display image generation unit 54 by using data of a future photographed image of the user U which is calculated by using data of the past photographed image of the user U recorded in the image information record unit 33 and data of a current photographed image of the user U. Concretely, for example, the display image generation unit 54 calculates a future shape of the user U based on difference of shapes of the user U respectively included in data of past and current photographed images of the user U, by using a predetermined function such as a correlation function and a prediction function, so as to generate the user image UP43.

In the superimposition display mode, the user images UP41 to UP43 are respectively displayed so that the user images UP41 to UP43 can be recognized in a time-series fashion. Concretely, the user images UP41 to UP43 are displayed such that transmittance increases in an order of the user image UP42, the user image UP41, and the user image UP43, namely, in an order of a past figure, a current figure, and a future figure of the user U, for example. As is obvious, display may be performed such that transmittance increases in an inverse order of the above order.

In terms of user images UP42 which show a past figure of the user U, display may be performed such that transmittance of the user image UP42 which is generated based on data of an older photographed image is high and transmittance of the user image UP42 which is generated based on data of a more current photographed image is low. In the same manner, in terms of user images UP43 which show a future figure of the user U, display may be performed such that transmittance of the user image UP43 which is generated based on more future prediction is high and transmittance of the user image UP43 which is generated based on data of a more current photographed image is low.

Thus, the user images UP41 to UP43 which respectively show a current figure, a past figure, and a future figure of the user U are superimposed and displayed on the display 11 in a time-series recognizable manner, so that the user U can easily perceive own body habitus change.

Here, the user images UP41 to UP43 may respectively show current, past, and future figures of someone who is not the user U. Further, the user images UP41 to UP43 may be images all of which show the same subject (that is, all images show the user U or other person who is not the user U) or images part of which shows other subject (that is, the user U and other person who is not the user U are mixed). Further, all of the user images UP41 to UP43 do not have to be superimposed on each other, but the user images UP41 to UP43 may be displayed such that arbitrary two of the user images UP41 to UP43 are superimposed on each other.

### [Display Example of Parallel Display Mode]

FIG. 11 illustrates a display example of a parallel display mode.

As depicted in FIG. 11, in the parallel display mode, the user image UP42 which shows a past figure of the user U is displayed next to the user image UP41 which shows a current figure of the user U. Here, the user images UP displayed in the parallel display mode are not limited to this, but arbitrary two of or all of the user images UP41 to UP43 may be displayed.

Thus, the user images UP41 to UP43 which respectively show a current figure, a past figure, and a future figure of the user U are displayed on the display 11 side by side in a manner to be recognized in a time-series fashion. Therefore, the user U can perceive own body habitus change while minutely checking her/his own body habitus of each of a current figure, a past figure, and a future figure.

In the parallel display mode as well, the user images UP41 to UP43 respectively show a current figure, a past figure, and a future figure of other person who is not the user U as is the case with the superimposition display mode. Further, the user images UP41 to UP43 may be images all of which show the same subject (that is, all images show the user U or other person who is not the user U) or images part of which shows other subject (that is, the user U and other person who is not the user U are mixed). Here, the user image UP42 which shows other person who is not the user U is generated by the display image generation unit 54 by using data, which is recorded in the image information record unit 33, of a photographed image which shows other person who is not the user U.

Though data of the user image UP is updated based on the moving amount Δx of the face of the user U in the above-described example, data of the user image UP may be updated based on the moving speed of the face of the user U. That is, the display type mirror apparatus 1 may generate data of the user image UP such that the display type mirror apparatus 1 increases the changing amount Δθ of the viewpoint P as the moving speed of the face of the user U increases.

Further, though the moving amount Δx of the face of the user U is a rotation angle of a case where the user U turns and moves her/his face in the horizontal direction, the turning direction may be a vertical direction. In this case, for example, when the user U looks up or stretches out, the display type mirror apparatus 1 may display the top of the head of the user U on the display 11, and when the user U looks down or crouches down, the display type mirror apparatus 1 may display a figure that the user U is viewed from the lower direction on the display 11.

Further, though the whole body of the user U is displayed on the display 11 in the above-described example, it is apparent that only the face, the upper body, or the lower body of the user U may be displayed.

Further, an image equivalent to a mirror image of a case where the display 11 is assumed as a mirror is displayed as the user image UP in the above-described example, but the user image UP is not limited to this. An image showing a figure of the user U which is viewed from others (that is, an image symmetrical with respect to the image equivalent to the mirror image) may be displayed as the user image UP. In this case, the former mode for displaying the user image UP is set to be a mirror mode and the latter mode for displaying the user image UP is set to be a normal mode so as to enable the user U to select an arbitrary display mode.

Further, the moving amount Δx of the face of the user U is detected by the face position detection unit 53 and data of the user image UP is updated based on the moving amount Δx in the above-described example, but it is not necessary to especially employ the face position detection unit 53. That is, a detection unit which can be used in updating data of an image of a subject and can detect a changing amount of a focused point of the subject may be employed as substitute for the face position detection unit 53. In other words, it is sufficient that such detection unit is employed in the display type mirror apparatus 1, and the face position detection unit 53 is merely an example of a detection unit of a case where the user U is employed as a subject and a region of the face of the user U included in a photographed image is employed as a focused point.

### [Application of Embodiment of Present Technology to Program]

The series of the processing described above may be performed either by hardware or software.

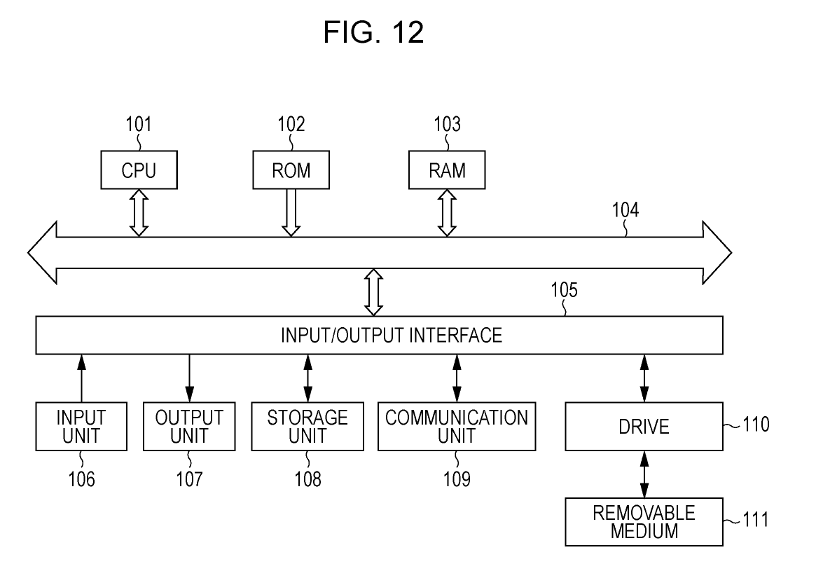

In this case, a personal computer depicted in FIG. 12, for example, may be employed as at least part of the above-described image processing apparatus.

In FIG. 12, a CPU 101 executes various processing in accordance with a program which is recorded in a ROM 102. Alternatively, the CPU 101 executes various processing in accordance with a program loaded on a RAM 103 from a storage unit 108. The RAM 103 arbitrarily records data necessary for execution of various processing of the CPU 101, for example.

The CPU 101, the ROM 102, and the RAM 103 are mutually connected via a bus 104. To this bus 104, an input/output interface 105 is connected as well.

To the input/output interface 105, an input unit 106 which is composed of a keyboard, a mouse, and the like, and an output unit 107 which is composed of a display and the like are connected. The storage unit 108 which is composed of hard disk and the like, and a communication unit 109 which is composed of a modem, a terminal adapter, and the like are further connected to the input/output interface 105. The communication unit 109 controls communication performed with other devices (not depicted) via a network including Internet.

A drive 110 is further connected to the input/output interface 105 as necessary, and a removable medium 111 which is a magnetic disk, an optical disk, a magneto-optical disk, a semiconductor memory, or the like is arbitrarily attached. A computer program read out from the removable medium 111 is installed on the storage unit 108 as necessary.

In a case where the series of processing is performed by software, a program constituting the software is installed from a network or a recording medium into a computer incorporated in dedicated hardware or into a general-purpose computer, for example, which is capable of performing various functions when various programs are installed.

A recoding medium containing such program is composed not only of removable media (package media) 211 but also of the ROM 102 in which a program is recorded and a hard disk included in the storage unit 108 as depicted in FIG. 12. The removable media 211 are distributed to provide programs for the user separately from the device body and are a magnetic disk (including a floppy disk), an optical disk (including a compact disk-read only memory (CD-ROM), and a digital versatile disk (DVD)), a magneto-optical disk (including a mini-disk (MD)), a semiconductor memory, or the like. The ROM 102 and the hard disk have been incorporated in the device body.

A step of describing a program which is recorded in the recording medium includes not only processing performed in time series along with the order but also processing which is not necessarily processed in time series but processed in parallel or individually, in this specification.

It should be understood that embodiments of the present technology are not limited to the above-described embodiment and various alterations may occur within the scope of the present technology.

The embodiments of the present technology may employ the following configuration as well.

(1) An image processing apparatus includes an image generation unit configured to generate an image that is obtained by photographing a subject from a different viewpoint or an image equivalent to the image obtained by photographing the subject from the different viewpoint, in conjunction with a changing amount of an attention part of the subject, as a subject image, and a display control unit configured to allow a display screen to display the subject image that is generated by the image generation unit.

(2) In the image processing apparatus according to (1), the image generation unit generates an image that is obtained by photographing the subject from a viewpoint of a reference position and a reference direction and an image equivalent to the image that is obtained by photographing the subject from the viewpoint of the reference position and the reference direction, as a reference subject image, and changes at least one of the position and the direction of the viewpoint in conjunction with the changing amount when the attention part of the subject changes from an initial state in which the reference subject image is generated, so as to generate an image that is obtained by photographing the subject from the changed viewpoint or an image equivalent to the image that is obtained by photographing the subject from the changed viewpoint, as the subject image.

(3) The image processing apparatus according to (1) or (2) further includes a detection unit configured to detect a changing amount of an attention part of the subject. In the image processing apparatus, the image generation unit generates the subject image in conjunction with the changing amount that is detected by the detection unit.

(4) The image processing apparatus according to (1), (2), or (3) further includes a plurality of photographing units that are respectively disposed on different positions and photograph the subject in separate photographing directions so as to respectively output data of photographed images. In the image processing apparatus, when the position and the direction of the changed viewpoint are not accorded with a setting position and a photographing direction of any photographing unit among the plurality of photographing units, the image generation unit composites data of photographed images outputted from photographing units that are selected from the plurality of photographing units so as to generate an image equivalent to an image obtained by photographing the subject from the changed viewpoint, as the subject image.

(5) In the image processing apparatus according to any of (1) to (4), the changing amount of the attention part of the subject is a rotation angle of a case where the attention part of the subject is turned and moved from the initial state.

(6) In the image processing apparatus according to any of (1) to (5), a rotating direction is in a horizontal direction.

(7) In the image processing apparatus according to any of (1) to (6), the rotating direction is in a vertical direction.

(8) In the image processing apparatus according to any of (1) to (7), the changing amount of a case where a composite image is a still image is a changing amount of an operation content of a gesture of the subject.

(9) In the image processing apparatus according to any of (1) to (8), the changing amount of a case where the composite image is a moving image is a changing amount of a position of a face of the subject or a changing amount of a direction of a line of sight of the subject.

(10) In the image processing apparatus according to any of (1) to (9), the image generation unit generates the subject image so that a size of the subject image and a display region of the subject image on the display screen are accorded with a size of the reference subject image and a display region of the reference subject image on the display screen.

(11) In the image processing apparatus according to any of (1) to (10), the subject image is an image that is obtained by photographing a past figure of the subject or an image equivalent to the image of the past figure of the subject.

(12) In the image processing apparatus according to any of (1) to (11), the subject image is an image that is obtained by photographing another subject that is different from the subject or an image equivalent to the image that is obtained by photographing the other subject.

(13) In the image processing apparatus according to any of (1) to (12), the display control unit allows to superimpose two or more images among an image obtained by photographing a past figure of the subject or an image equivalent to the image obtained by photographing the past figure of the subject, an image obtained by photographing a current figure of the subject or an image equivalent to the image obtained by photographing the current figure of the subject, and an image obtained by photographing a future figure of the subject or an image equivalent to the image obtained by photographing the future figure of the subject, as the subject image so as to display the superimposed image.

(14) In the image processing apparatus according to any of (1) to (13), the display control unit allows to display two or more images side by side among the image obtained by photographing the past figure of the subject or the image equivalent to the image obtained by photographing the past figure of the subject, the image obtained by photographing the current figure of the subject or the image equivalent to the image obtained by photographing the current figure of the subject, and the image obtained by photographing the future figure of the subject or the image equivalent to the image obtained by photographing the future figure of the subject, as the subject image.

(15) In the image processing apparatus according to any of (1) to (14), the display control unit allows to display the image obtained by photographing the past figure of the subject or the image equivalent to the image obtained by photographing the past figure of the subject, the image obtained by photographing the current figure of the subject or the image equivalent to the image obtained by photographing the current figure of the subject, and the image obtained by photographing the future figure of the subject or the image equivalent to the image obtained by photographing the future figure of the subject, in a manner to make the respective images have different transmittance.

The embodiments of the present technology are applicable to an image processing apparatus which displays an image of a subject.

The present disclosure contains subject matter related to that disclosed in Japanese Priority Patent Application JP 2011-108843 filed in the Japan Patent Office on May 13, 2011, the entire contents of which are hereby incorporated by reference.

What is claimed is:

1. An image processing apparatus, comprising:
an image generation unit configured to generate an image that is obtained by photographing a subject from a different viewpoint or an image equivalent to the image obtained by photographing the subject from the different viewpoint, in conjunction with a changing amount of an attention part of the subject, as a subject image; and
a display control unit configured to allow a display screen to display the subject image that is generated by the image generation unit.

2. The image processing apparatus according to claim 1, wherein
the image generation unit
generates an image that is obtained by photographing the subject from a viewpoint of a reference position and a reference direction and an image equivalent to the image that is obtained by photographing the subject from the viewpoint of the reference position and the reference direction, as a reference subject image, and
changes at least one of the position and the direction of the viewpoint in conjunction with the changing amount when the attention part of the subject changes from an initial state in which the reference subject image is generated, so as to generate an image that is obtained by photographing the subject from the changed viewpoint or an image equivalent to the image that is obtained by photographing the subject from the changed viewpoint, as the subject image.

3. The image processing apparatus according to claim 2, further comprising:
a detection unit configured to detect a changing amount of an attention part of the subject, wherein
the image generation unit generates the subject image in conjunction with the changing amount that is detected by the detection unit.

4. The image processing apparatus according to claim 3, further comprising:
a plurality of photographing units that are respectively disposed on different positions and photograph the subject in separate photographing directions so as to respectively output data of photographed images, wherein
when the position and the direction of the changed viewpoint are not accorded with a setting position and a photographing direction of any photographing unit among the plurality of photographing units, the image generation unit composites data of photographed images outputted from photographing units that are selected from the plurality of photographing units so as to generate an image equivalent to an image obtained by photographing the subject from the changed viewpoint, as the subject image.

5. The image processing apparatus according to claim 4, wherein the changing amount of the attention part of the subject is a rotation angle of a case where the attention part of the subject is turned and moved from the initial state.

6. The image processing apparatus according to claim 5, wherein a rotating direction is in a horizontal direction.

7. The image processing apparatus according to claim 5, wherein the rotating direction is in a vertical direction.

8. The image processing apparatus according to claim 6, wherein the changing amount of a case where a composite image is a still image is a changing amount of an operation content of a gesture of the subject.

9. The image processing apparatus according to claim 6, wherein the changing amount of a case where the composite image is a moving image is a changing amount of a position of a face of the subject or a changing amount of a direction of a line of sight of the subject.

10. The image processing apparatus according to claim 8, wherein the image generation unit generates the subject image so that a size of the subject image and a display region of the subject image on the display screen are accorded with a size of the reference subject image and a display region of the reference subject image on the display screen.

11. The image processing apparatus according to claim 10, wherein the subject image is an image that is obtained by photographing a past figure of the subject or an image equivalent to the image of the past figure of the subject.

12. The image processing apparatus according to claim 10, wherein the subject image is an image that is obtained by photographing another subject that is different from the subject or an image equivalent to the image that is obtained by photographing the other subject.

13. The image processing apparatus according to claim 10, wherein the display control unit allows to superimpose two or more images among an image obtained by photographing a past figure of the subject or an image equivalent to the image obtained by photographing the past figure of the subject, an image obtained by photographing a current figure of the subject or an image equivalent to the image obtained by photographing the current figure of the subject, and an image obtained by photographing a future figure of the subject or an image equivalent to the image obtained by photographing the future figure of the subject, as the subject image so as to display the superimposed image.

14. The image processing apparatus according to claim 10, wherein the display control unit allows to display two or more images side by side among the image obtained by photographing the past figure of the subject or the image equivalent to the image obtained by photographing the past figure of the subject, the image obtained by photographing the current figure of the subject or the image equivalent to the image obtained by photographing the current figure of the subject, and the image obtained by photographing the future figure of the subject or the image equivalent to the image obtained by photographing the future figure of the subject, as the subject image.

15. The image processing apparatus according to claim 13, wherein the display control unit allows to display the image obtained by photographing the past figure of the subject or the image equivalent to the image obtained by photographing the past figure of the subject, the image obtained by photographing the current figure of the subject or the image equivalent to the image obtained by photographing the current figure of the subject, and the image obtained by photographing the future figure of the subject or the image equivalent to the image obtained by photographing the future figure of the subject, in a manner to make the respective images have different transmittance.

16. An image processing method, comprising:
generating an image that is obtained by photographing a subject from a different viewpoint or an image equivalent to the image obtained by photographing the subject from the different viewpoint, in conjunction with a changing amount of an attention part of the subject, as a subject image; and
allowing a display screen to display the subject image that is generated in the generating an image.
